(19) United States
(12) Patent Application Publication
(10) Pub. No.: US 2026/0305809 A1
(43) Pub. Date: Oct. 8, 2026

(54) Combination Toothbrush and Toothpaste Dispenser

(71) Applicant: Safiah Guerras, Riyadh (SA)

(72) Inventor: Safiah Guerras, Riyadh (SA)

(21) Appl. No.: 19/481,769

(22) PCT Filed: Feb. 26, 2024
(86) PCT No.: PCT/IB2024/000105

§ 371 Date: Nov. 5, 2025

Related U.S. Application Data
(63) Continuation-in-part of application No. 18/313,582, filed on May 8, 2023, now Pat. No. 11,910,910.

(51) Int. Cl. A46B 11/00; A45D 44/18; A46B 9/04; A46B 17/04

(52) U.S. Cl. CPC A46B 11/0075; A45D 44/18; A46B 9/04; A46B 11/0037; A46B 17/04; A46B 2200/1066

(57) ABSTRACT

A toothbrush configured to dispense toothpaste and dental floss, the toothbrush having a handle, a head, and a chamber defined by the handle and the head into which toothpaste can be inserted directly or in a tube. The head of the toothbrush defines a hole and the handle is configured to dispense the toothpaste through the hole and onto bristles on the head of the toothbrush. A cap can be provided to cover the bristles. The cap can also include a spike that is used to puncture a hole in a tube of toothpaste or to plug the hole when not in use.

### FIELD OF THE INVENTION

The present invention is directed towards toothbrushes and toothpaste dispensers, and in particular, the combination of a toothbrush with a toothpaste dispenser, and optionally a dental floss holder.

### BACKGROUND OF THE INVENTION

It is desirable for travelers to minimize items they carry so as to reduce luggage size and weight, including toiletries. In general, travelers will bring a toothbrush and toothpaste as separate items. Some will bring dental floss, while others will forget. Although travel size toothpastes exist, the toothpaste and toothbrush are typically two separate items. Oftentimes, the traveler will end up bringing a full size toothpaste.

The toothpaste also has a cap that has to be removed in order to dispense the toothpaste. This extra step may be a minor inconvenience for typical travelers, but can be a bigger nuisance for those who may have a disability with one of their hands.

As such, there is a need for an improved and more efficient toothbrush that packages dental hygiene items into a single item that is easy to use, even for those who may be limited to one hand.

### BRIEF DESCRIPTION OF THE DRAWINGS

FIG. 1 is a perspective view of an embodiment of the present invention.

FIG. 2 is a cross section view taken along line 2-2 in FIG. 1.

FIG. 3 is an exploded view of an embodiment of the present invention.

FIG. 4 is an exploded view of another embodiment of the present invention.

FIG. 5 is a perspective view of another embodiment of the present invention.

FIG. 6 is an exploded view of the embodiment in FIG. 5.

FIG. 7 is a cross-sectional view of the embodiment in FIG. 5 taken along line 7-7, but only showing the head portion.

FIG. 8 is a close-up of the portion labeled 8 in FIG. 7.

FIG. 9 is an exploded perspective view from the top of another embodiment of the present invention.

FIG. 10 is an exploded perspective view from the bottom of the embodiment shown in FIG. 9, but without the cap and lid.

### SUMMARY OF THE INVENTION

The invention of the present application is directed towards a toothbrush with a toothpaste dispenser incorporated therein, and optionally, and a dental floss holder. The toothpaste is contained in the handle between the lower housing and a flexible piece of film that is welded along its edges around the seam between the upper housing and the lower housing. The toothpaste chamber is completely sealed between the flexible film and the lower housing until the cap is placed over the bristles. A spike protruding from the cap then pierces the flexible film, which allows the toothpaste to flow out of the toothpaste chamber through the hole that has been created in the flexible film. When the slider is moved towards the bristles, the film is depressed by an internal bumper and is forced towards the bristles. When the cap is replaced back over the bristles, the spike protrudes into the toothpaste port and prevents additional toothpaste from flowing out of the toothpaste chamber.

A bristle cap comprises a lower cap and an upper cap or lid. A floss spool is located inside the bristle cap between the bristle compartment and the handle of the toothbrush. The floss spool is separated from the toothbrush bristles by a waterproof barrier that prevents water on the bristles from contaminating the dental floss contained on the floss spool. The dental floss passes through a rubber O-ring that is sandwiched between the upper cap and the lower cap. The O-ring prevents water from flowing into the floss compartment and contaminating the dental floss. A flat removable spacer may be placed between the cap and the toothbrush during shipping to prevent the spike from piercing the flexible film. The spacer may be a sheet of cardboard with a written message on it.

### DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

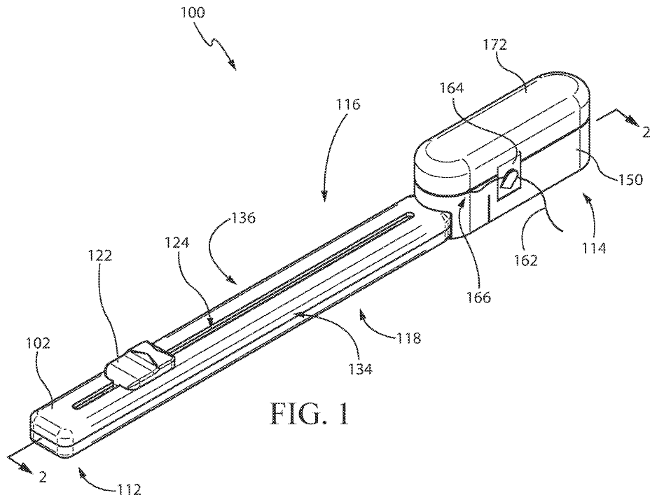

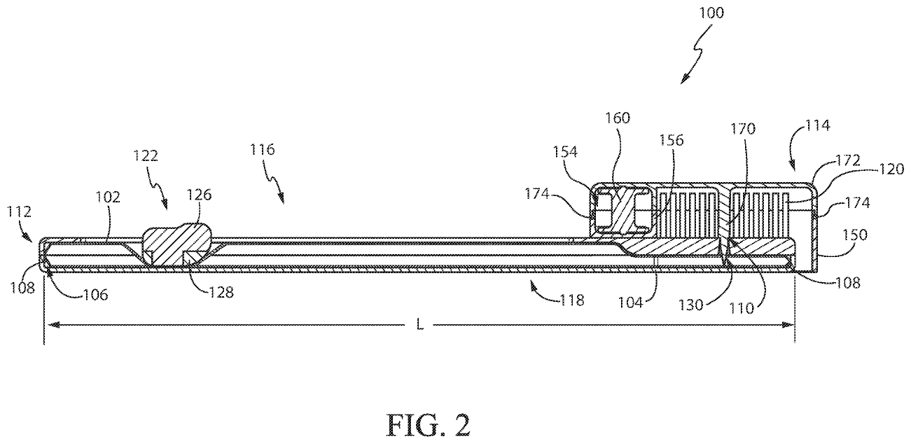

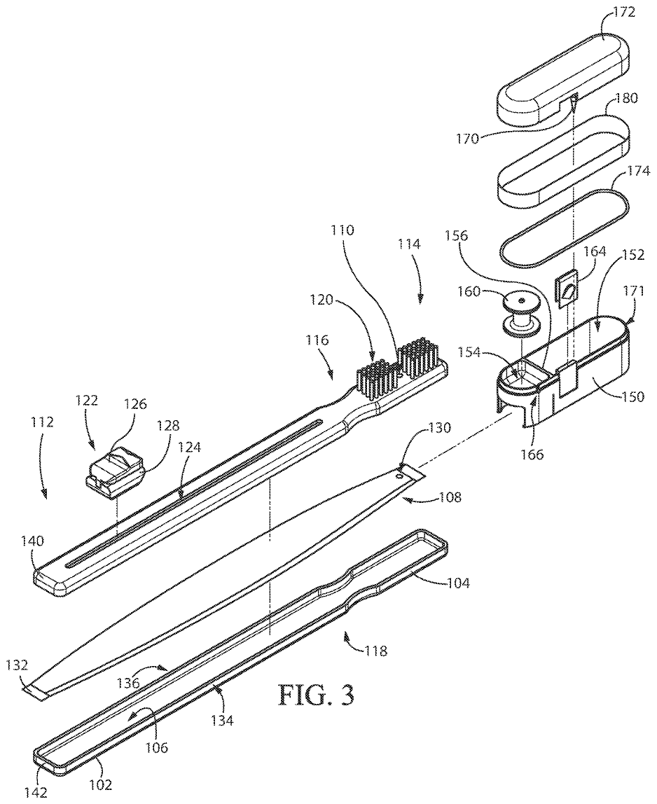

With reference to FIGS. 1-3, the invention of the present application is directed towards a toothbrush 100 with toothpaste dispenser, the toothbrush 100 comprising a handle 102 and a head 104, wherein the handle 102 and the head 104 define a chamber 106 in which a tube 108 of toothpaste can be housed. The head 104 comprises a hole 110 that aligns with a hole 130 created in the tube 108 of toothpaste upon first use, such that when the tube 108 of toothpaste is squeezed, toothpaste from within the tube 108 passes out of the hole 130 of the tube 108, and through the hole 110 in the head 104 of the toothbrush 100.

The toothbrush 100 comprises a proximal end 112, a distal end 114 opposite the proximal end 112, a top side 116 in between the proximal end 112 and the distal end 114, and a bottom side 118 opposite the top side 116 and in between the proximal end 112 and the distal end 114. The handle 102 is positioned at the proximal end. As such, at least a portion of the handle 102 can define the proximal end 112 as that is the end that is proximal to the user when held for use.

The head 104 is operatively connected to the handle 102 at the distal end 114. As such, at least a portion of the head 104 can define the distal end 114. The handle 102 and the head 104 define a length L of the toothbrush 100 from the proximal end 112 to the distal end 114. The head 104 can be operatively connected to the handle 102 by being attached to the handle 102 or by being integrally formed with the handle 102. In the preferred embodiment, the handle 102 is integrally formed with the head 104. The handle 102 and the head 104 define a chamber 106 configured to receive the tube 108 of toothpaste. In the preferred embodiment, the tube 108 of toothpaste extends the full length L of the toothbrush 100 from the handle 102 at the proximal end 112 into the head 104 at the distal end 114. The head 104 defines a hole 110 in fluid communications with the chamber 106. As such, when the tube 108 of the toothpaste is punctured adjacent the hole 110 of the head 104 and then squeezed, the toothpaste inside the tube 108 passes through the hole 110 in the head 104 an onto the bristles 120.

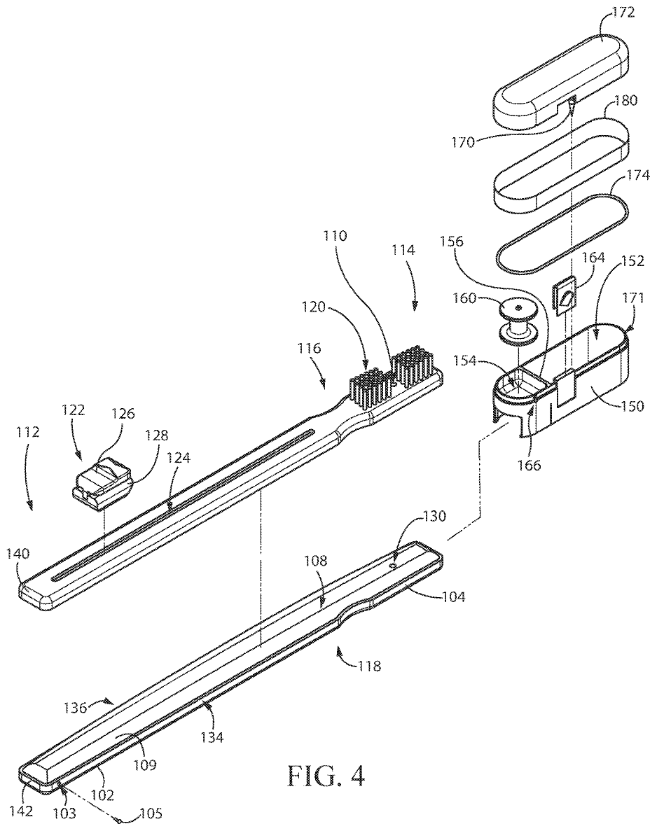

A plurality of bristles 120 can project from the head 104 on the top side 116 of the toothbrush 100 like a standard toothbrush. In the present invention, the bristles 120 surround the hole 110 in the head 104 of the toothbrush 100. FIG. 4 does not show bristles lateral to the hole 110 so that the hole 110 can be seen. In the preferred embodiment, bristles 120 can surround the hole 110 on all sides. Preferably, the hole 110 is located approximately at the center of the head 104 for generally even distribution of the toothpaste onto the bristles 120. The hole 110 can also be placed anywhere else on the top side 116 of the head 104 because the brushing action will eventually spread the toothpaste all over the bristles 120.

To expel the toothpaste from the tube 108, in some embodiments, a dispenser 122 can be mounted on the handle 102 and configured to move back and forth longitudinally along the handle 102 in a direction from the proximal end 112 towards the distal end 114 (and back). For example, the handle 102 can have an elongated slit 124. The dispenser 122 can comprise a slider 126 that resides sufficiently on the outside of the handle 102 to be accessible by the user, and a bumper 128 operatively connected to the slider 126 through the slit 124 that is housed inside the chamber 106. The bumper 128 abuts against the tube 108. A hole 130 can be created in the tube 108 adjacent to the hole 110 in the head 104. As the slider 126 is advanced along the slit 124 on the handle 102, the bumper 128 squeezes the tube 108 in the direction towards the head 104. The toothpaste inside the tube 108 follows the path of least resistance, which is through the hole 130 in the tube 108, which leads to the hole 110 in the head 104 an onto the bristles 120.

To keep the tube 108 stationary as the bumper 128 rides along the tube 108, the tube 108 can have a seam where to flat sections of the tube 108 are mated together, thereby creating a flap 132. In some embodiments, the flap 132 can be a single layer of material. For example, the flap 132 can be an extension of a top layer of the tube 108 beyond a bottom layer, or an extension of the bottom layer of the tube 108 beyond the top layer, or a new layer attached to the ends of the tube 108. The flap 132 can be at the proximal end 112, the distal end 114, the lateral sides 134, 136, or any combination thereof, including along the entire perimeter of the tube 108. By creating a flap 132 along the perimeter edges of the tube 108, the flap 132 can be attached to the handle 102 and/or head 104 without inadvertently squeezing the tube 108.

For example, in some embodiments, the handle 102 (and head 104) can comprise an upper housing 140, and a lower housing 142. The upper housing 140 can be removably connected to the lower housing 142. The tube 108 can be configured to fit inside the chamber 106 in a manner that allows the flap 132 of the tube 108 to extend out far enough to be sandwiched (pinched) between the upper housing 140 and the lower housing 142. The sandwiched flap 132 then prevents the tube 108 as a whole from generally moving in the distal direction as the dispenser 122 is moved towards the distal end 114.

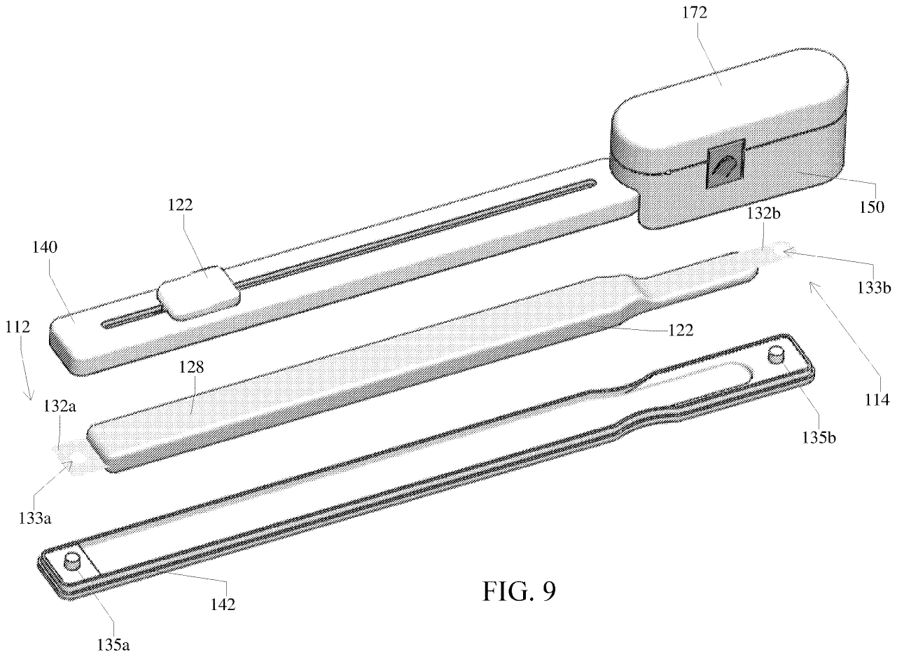

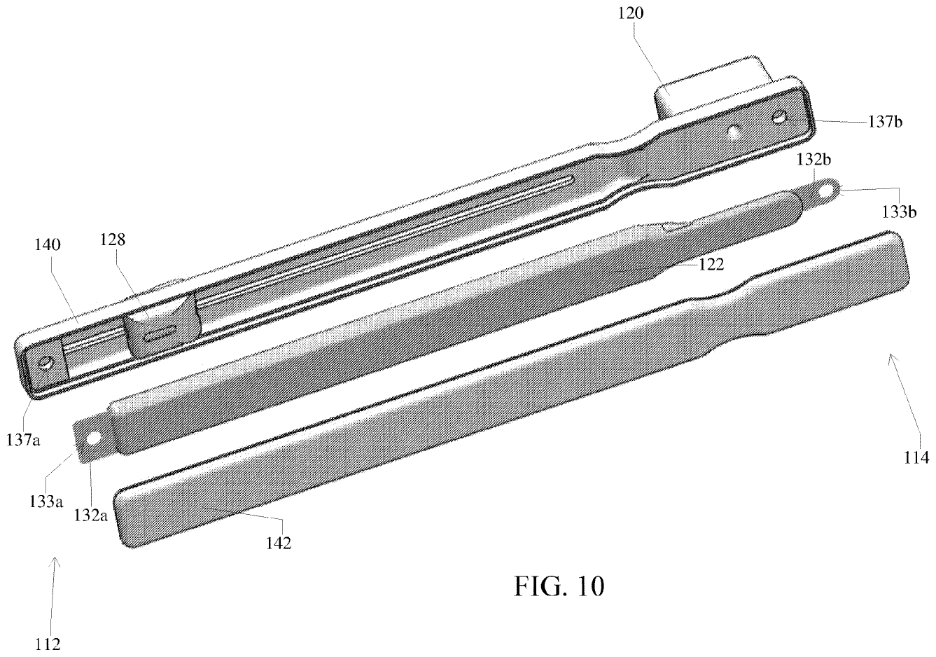

The tube 108 can be secured inside the handle 102 and head 104 in other ways, such as by using locating pegs, clips, hooks, clamps, or any other kind of a catch 135 and the like that can secure the flap 132. For example, with reference to FIGS. 9-10, the flaps 132a, 132b at the proximal end 112 and/or the distal end 114 can define a hole 133a, 133b. Either the upper housing 140 or the lower housing 142 can comprise a catch 135a, 135b to connect with the flap 132a, 132b. In this example, the catch 135a, 135b is a peg on the lower housing 142 that can be inserted into the hole 133a, 133b of the seam 132a, 132b. The upper housing 140 can have a reciprocal catch 137a, 137b, such as a receiving hole to receive the peg. As such, the pegs can be inserted into the holes 133a, 133b of the flaps 132a, 132b and then into the receiving holes 137a, 137b of the upper housing 140 to secure the tube 108 in place. The catch 135a, 135b can also be placed on the upper housing 140 with the reciprocal catch 137a, 137b on the lower housing 142. Therefore, the tube can comprise a first flap 132a at the proximal end 112 and a second flap 132b at the distal end 114, wherein one of the lower housing 142 or the upper housing 140 comprises a first catch 135a at the proximal end 112 and a second catch 135b at the distal end 114, and the other of the lower housing 142 or upper housing 140 comprises a first reciprocal catch 137a at the proximal end 112 and a second reciprocal catch 137b at the distal end 114, wherein the first catch 135a is connected to the first reciprocal catch 137a with the first flap 132a therebetween, and the second catch 135b is connected to the second reciprocal catch 137b with the second flap 132b therebetween.

Other embodiments for squeezing the tube 108 to expel the toothpaste onto the bristles have also been contemplated. For example, in some embodiments the top side 116 or the bottom side 118 of the handle 102 may be pliable. Rather than running a dispenser 122 along the handle 102, the user can simply squeeze the pliable portion of the handle 102. In such an embodiment, the pliable portion of the handle 102 can be made of any kind of flexible film 109. For example, in FIG. 4, the upper housing 140 may be omitted, except at the head 104 where the bristles 120 are mounted. The flexible film 109 is to be interpreted broadly to include any kind of pliable material that can contain toothpaste, such as plastic, rubber, polyethylene, plastic laminates, such as those used in typical squeezable toothpaste containers, and the like. In such embodiments, a sliding dispenser 122 and replaceable tube 108 may not be required, but still can be used. As such, the toothbrush 100 can be disposed of after the toothpaste has run out. Preferably, the pliable portion is on the top side 116 of the handle 102 and the bottom side 118 of the handle 102 is rigid, as shown in FIG. 4.

In some embodiments, the flexible piece of film 109 can be operatively connected to the lower housing 142 by being integrally formed or attached with the lower housing 142, and optionally, the upper housing 140. For example, the film 109 can be attached along its edges around the flap 132 between the upper housing 140 and/or the lower housing 142. FIG. 4 shows the film welded along the perimeter edge of the lower housing 142. The toothpaste chamber 106 is completely sealed between the flexible film 109 and the lower housing 142. When the cap 150 is placed over the bristles 120. The spike 170 protruding from the cap 150 then pierces the flexible film 109, which allows the toothpaste to flow out of the toothpaste chamber 106 through the hole 130 that has been created in the flexible film 109. When the dispenser 122 is moved towards the bristles 120, the film 109 is depressed by an internal bumper 128 and is forced towards the bristles 120. The film 109 can be a portion of the tube 108. As such, in some embodiments, the film 109 can be folded and sealed to create the tube 108 and function as the tube 108 discussed above.

When empty, the film 109 is loose and rests on the floor of the lower housing 142 with the edges of the film 109 sealed against the lower housing 142. The lower housing 142 can have an opening 103 through which toothpaste can be injected into the lower housing 142. Filling the lower housing 142 with toothpaste causes the film 109 to rise and fill the chamber 106 created in between the film 109 and the lower housing 142. As such, the chamber 106 into which the toothpaste is housed can be defined by the space between the lower housing 142 and the film 109. A plug 105 can be used to close the opening 103 after filling with toothpaste. The plug 105 can be any kind of a stopper or cap to prevent backflow of the toothpaste when pressure is applied to the film 109. The upper housing 140 can be placed on top of the film 109 and connected to the lower housing 142 to seal the film 109 and toothpaste inside.

The toothbrush 100 further comprises a cap 150. The cap 150 has multiple functions. For example, the cap 150 can be used to cover the bristles 120, the cap 150 can be used to house dental floss 162, and the cap 150 can be configured to puncture a hole 130 in the tube 108. As such, in the preferred embodiment, the cap 150 defines a first compartment 152 configured to receive the head 104 and the bristles 120. In some embodiments, the cap 150 can further define a second compartment 154 adjacent to the first compartment 152. For example, the cap 150 can comprise a barrier 156 that separates the cap 150 into a first compartment 152 and a second compartment 154 adjacent to the first compartment 152.

In some embodiments, the toothbrush 100 can further comprise a floss spool 160. While the head 104 and bristles 120 can occupy the first compartment 152 of the cap 150, the floss spool 160 can be mounted in the second compartment 154. Dental floss 162 can be wrapped around the floss spool 160 and drawn out from the cap 150 as necessary. As such, the toothbrush 100 can further comprise a floss cutter 164. Preferably, the floss cutter 164 is mounted on the cap 150 adjacent to the floss spool 160. The cap 150 can define an exit port 166 configured for extracting the dental floss 162 out from the cap 150.

To puncture the hole 130 in the tube 108, the cap 150 can comprise a spike 170 projecting into the first compartment 152 and configured to enter the hole 110 of the head 104 when the cap 150 is placed on the head 104. As such, the cap 150 may comprise a ceiling or lid 172 from which the spike 170 descends into the chamber 106. In the preferred embodiment, the cap 150 has an open top 171. The toothbrush 100 can further comprise a lid 172 to cover the open top 171. In such an embodiment, the spike 170 can be mounted on the lid 172. In some embodiments, the lid 172 is removable from the cap 150. In some embodiments, the lid 172 is integrally formed with the cap 150 as a single unit. In embodiments with a removable lid 172, the toothbrush 100 can further comprise a gasket 174 configured to be sandwiched between the removable lid 172 and the cap 150 to create a water tight seal around the second compartment 154. As such, the gasket can be an o-ring, a grommet, or any other type of sealer made from material such as silicone, rubber, plastic, and the like. The gasket 174 can be configured to allow the dental floss 162 to pass through the exit port 166.

In some embodiments, the toothbrush 100 can further comprise a spacer 180 configured to be positioned between the lid 172 and the cap 150 to create a distance between the cap 150 and the lid 172 sufficient to prevent the spike 170 on the lid 172 from entering the hole 110 in the head 104. The spacer 180 is particularly useful when the toothbrush 100 is being transported or stored and the tube 108 of toothpaste is brand new (i.e. without hole 130). Then the tube 108 of toothpaste is not prematurely opened.

In use, the user can discard the spacer 180 in the embodiment with a lid 172 by removing the lid 172 from the cap 150, then removing the spacer 180. Upon replacing the lid 172 back on the cap 150, in the absence of the spacer 180, the spike 170 on the lid 172 enters the hole 110 on the head 104 of the toothbrush 100 and punctures the tube 108 to create a hole 130 in the tube 108 directly adjacent to the hole 110 on the head 104. The user can then remove the lid 172 and the cap 150. The user can then slide the dispenser 122 at the proximal end 112 slightly towards the distal end 114 by pushing on the slider 126. Doing so causes the bumper 128 of the dispenser 122 to squeeze the tube 108. The toothpaste inside the tube 108 follows the path of least resistance, which would be through the hole 130. Pressure at the proximal end 112 of the tube 108 may cause the distal end 114 to bulge making the hole 130 in the tube 108 contiguous with the hole 110 in the head 104. As such, the toothpaste flows from the tube 108 out onto the head 104 of the toothbrush and into the bristles 120. The user can brush his or her teeth, and if more toothpaste is needed, simply slide the dispenser 122 even further closer to the distal end 114.

Upon completion of brushing, the cap 150 is placed back on the head 104 of the toothbrush 100 to cover the bristles 120. The spike 170 enters the hole 110 in the head 104, and can even enter into the hole 130 in the tube 108 to block excess toothpaste from being dispensed when the user is not brushing his or her teeth. As such, the spike 170 functions as a plug to prevent toothpaste from continuing to exit onto the bristles 120.

To floss the teeth (before or after brushing), dental floss 162 on the floss spool 162 can be pulled slightly to extend out from the exit port 166. The lid 172 can be returned back on the cap 150. The user can pull the dental floss 162 and cut the floss 162 on the floss cutter 164 and floss his or her teeth.

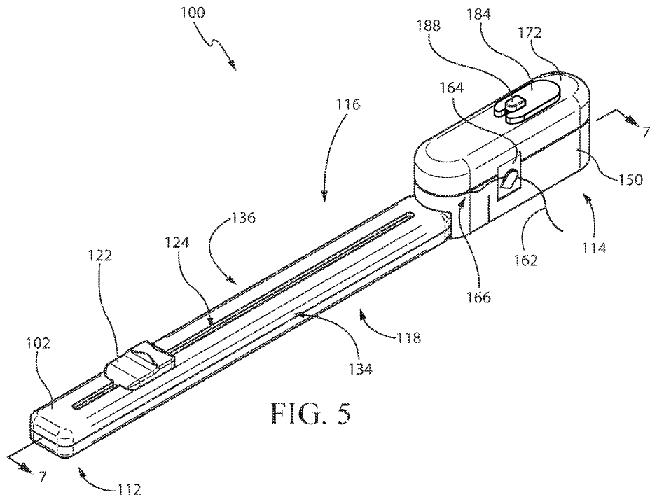

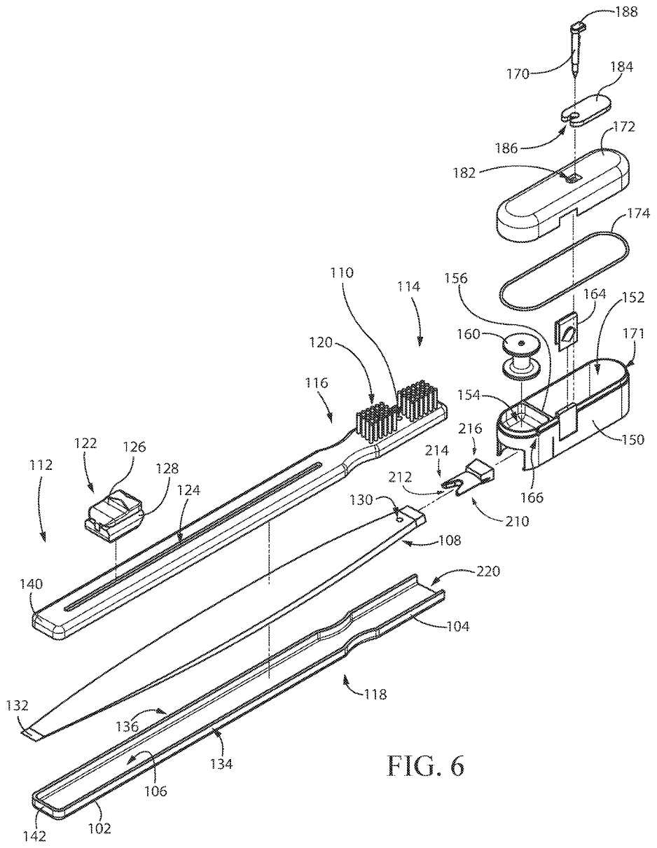

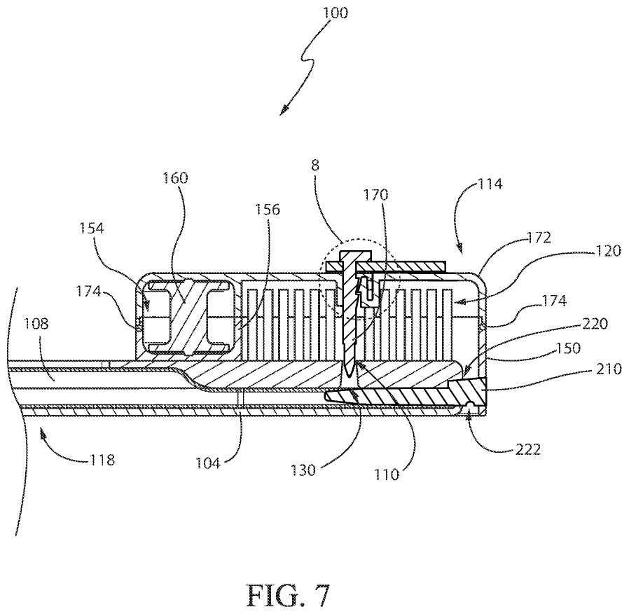

With reference to FIGS. 5-7, in some embodiments, to prevent the spike 170 from inadvertently puncturing the tube 108, the spike 170 can be separate from the lid 172, and moveable relative to the lid 172. As such, the lid 172 can define a hole 182 through which the spike 170 can be inserted and move from a reset configuration in which the spike 170 is away from the tube 108 to a depressed configuration in which the spike 170 punctures the tube 108. A lock 184, such as a locking tab, may be provided on top of the lid 172 to hold the spike 170 in place in the reset configuration above the tube 108 so as not to puncture the tube 108. In the preferred embodiment, the lock 184 is a flat piece with an opening 186 at one end. The spike 170 comprises a button 188 at the top end. The spike 170 is configured to slide through the opening 186 of the lock 184 and the hole 182 on top of the lid 172. The button 188 is configured to be larger than the opening 186 of the lock 184. As such, the button 188 is caught at the lock 184. The lock 184 van be configured to slide along the surface of the lid 172 from a locked configuration in which the spike 170 is locked in the reset configuration, to an unlocked configuration in which the spike 170 can be depressed. As such, when the lock 184 is slid away from the spike 170, or otherwise removed, to the unlocked configuration, the spike 170 can be depressed to a depressed configuration bypassing the lock 184 and progressing further into the hole 182 of the lid 172. With the lock 184 in the unlocked configuration, the spike 170 can be depressed far enough through the lid 172 to puncture the tube 108. As such, with the button 188 and lock 184 configuration, the toothbrush 100 can be packaged with the cap 150 and lid 172 snapped into place over the bristles 120 prior to the first use of the toothbrush 100. This allows the toothbrush 100 to be packaged so that it requires a minimum amount of space. Although the lock 184 is shown as a tab, any other lock can be used to prevent the spike 170 from moving, such as clips, clamps, pins, hooks, and the like.

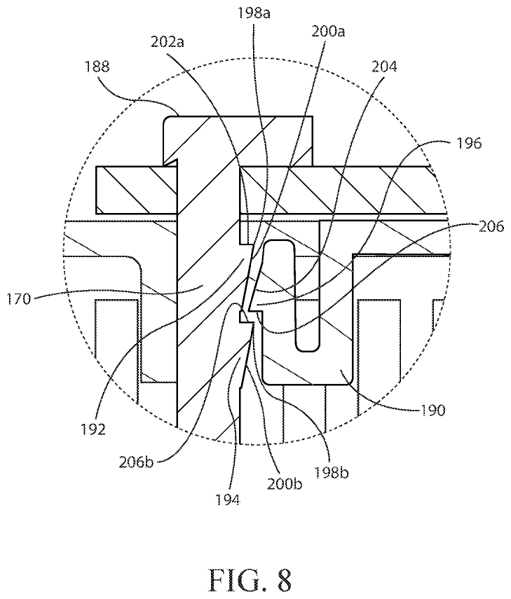

In some embodiments, to control the spike 170 position, the lid 172 can comprise a spring 190 configured to bias against the spike 170. Any other kind of biasing mechanism can function as the spring 190 by creating a force against the spike 170 to keep the spike 170 in place, such as coil springs, leaf springs, elastic material, and the like. For example, as seen best in FIG. 8, the spike 170 can have one or more protrusions to interact with the spring 190 to hold the spike 170 in place and to prevent the spike 170 from being completely dislodged from the lid 172. In the preferred embodiment, the spike 170 can comprise an upper protrusion 192 and a lower protrusion 194 arranged in series along the length of the spike 170. More preferably, the upper protrusion 192 and the lower protrusion 194 are each in the form of ramped teeth with each having a ramped surface 200a, 200b descending from the apex 198a, 198b of each respective wall 202a, 202b, with each ramped surface 200a, 200b descending towards the point of the spike 170, and the walls 202a, 202b facing towards the button 188.

The spring 190 is configured to bias in the direction generally perpendicular toward the spike 170. Preferably, the spring 190 also comprises a ramped tooth 196 that is reciprocally oriented relative to the upper protrusion 192 and the lower protrusion 194. As such, the ramped tooth 196 of the spring 190 also comprises a ramped surface 204 and a wall 206, but the ramped surface 204 of the spring 190 descends towards the button 188, and the wall 206 of the spring 190 faces towards the tube 108.

With the spike 170 in the reset configuration and the locking tab 184 in place, the ramped surface 200a of the upper protrusion 192 is adjacent to and/or abuts against the ramped surface 204 of the spring 190. When the locking tab 184 is removed, the button 188 can be depressed, allowing the apex 198a of the upper protrusion 192 to slide up the ramped surface 204 of the spring 190 towards the wall 206 of the spring 190. This movement causes a biasing force against the ramped surface 200a of the upper protrusion 192. As such, when the force on the button 188 is removed, the ramped surface 204 of the spring 190 biases against the ramped surface 200a of the upper protrusion 192 causing the spike 170 to move upwardly towards its reset configuration. To prevent the spike 170 from being removed altogether, the wall 202b of the lower protrusion 194 can abut against the wall 206 of the spring. Because these are two flat faces, they cannot move passed each other thereby locking the spike 170 in place. Other biasing mechanisms can be utilized as well to cause the spike 170 to return to its reset configuration after being depressed.

In some embodiments, the length of the spike 170 is configured to allow the spike 170 to lock in the depressed configuration. As such, when the locking tab 184 is removed and the spike 170 depressed, the upper protrusion 192 can slide passed the ramped surface 204 on the spring 190 and lock in the depressed configuration with the wall 202a of the upper protrusion 194 immediately adjacent to the wall 206 of the spring 190. As such, the spike 170 cannot return to its reset configuration. Therefore, the user can remove the cap 150 and lid 172 to allow the toothpaste to flow out of the tube 108. When the cap 150 is returned to the head 104, the spike 170 functions as a stop to keep the holes 110, 130 in the head 104 and tube 108 blocked.

In some embodiments, the length of the spike 170 can be configured such that when the button 188 is flush with the hole 182 in the lid, the wall 202a of the upper protrusion 192 does not slide passed the wall 206 of the spring 190, preventing the spike 170 from being locked in the depressed configuration.

In some embodiments, to prevent the tube 108 from collapsing when the spike 170 is pushed into the tube 108, the tube 108 can comprise a stent 210. The stent 210 can provide added tension on the tube 108 around the location where the spike 170 penetrates the tube 108. The added tension allows the spike 170 to pierce through the tube 108 easily rather than causing the tube 108 to be depressed without puncturing. The stent 210 can be welded to the tube 108 using ultrasonic welding or the stent 210 can be configured to be removable from the tube 108. The stent 210 is made of a rigid material with an opening 212 at one end 214 (the interior end). The opening 212 can be a through-hole through the stent 210 or a cut out at the interior end 214. The cut out can be “U”-shaped “V”-shaped, semi-circular, and the like. As such, the interior end 214 of the stent 210 can be forked. When properly installed, the opening 212 of the stent 210 aligns with the spike 170 such that when the spike 170 is depressed, the pointed end of the spike 170 inserts into the tube 108 and through the opening 212 of the stent 210. The stent 210 provides structural support and/or tension in the tube 108 to allow the spike 170 to easily pierce through the tube 108.

The toothpaste tube 108 can be a removable cartridge making it easier to install and replace with new tube 108 if desired. The stent 210 can function as an external cap for the toothpaste tube 108 cartridge. The stent 210 allows the user to remove the toothpaste tube 108 through an opening 220, for example, at the proximal end 112 or the distal end 114 of the toothbrush housing. The stent 210 can function as a cap to close the opening 220, or a separate cap can be installed on the housing to contain the tube 108. In embodiments in which the stent 210 is the cap to contain the tube 108 inside the chamber 106 of the toothbrush, resistance fit or snap fit can be used to keep the stent 210 in place. A recess 222 can be provided for the user to use his or her fingernail to pull out the stent 210 and tube 108.

The toothbrush 100 of the present invention can be made using typical manufacturing process including using molds, extrusion techniques, 3-D printing, and the like. The invention can be made disposable so that the toothbrush 100 can be disposed of within a short period of time, such as a one-or two-week vacation. The invention can also be made for long term use with quality and sturdy material. In such an embodiment, only the tube 108 is disposed of and the handle 102 can be used long term for in the home. As such, when the toothpaste runs out, the tube 108 is removed and discarded, and a new tube 108 of toothpaste can be inserted into the same handle 102. In disposable embodiments, the materials used are preferably recyclable, biodegradable, or any other environmentally-friendly material, or any combination thereof.

In some embodiments, the tube 108 can comprise aluminum. In some embodiments, the tube 108 can be made from an impermeable barrier to keep the fluoride from escaping the tube 108. For example, the tube 108 can comprise a thermoplastic polymer, such as polyethylene terephthalate (PET), polyethylene (PE), and the like.

The configuration of the present invention allows all of the important items for dental hygiene to be kept in a single toothbrush 100. As such, this all-in-one (or three-in-one) toothbrush 100 is the ideal dental hygiene companion for travelers. Therefore, hotels, motels, resorts, airbnb's, cruise ships, and the like, can include the present invention as one of the perks of staying at their location. Alternatively, the toothbrush can be sold in airports, hotels, vending machines, pharmacies, convenient stores, as well as regular retail stores, and any other channel of sale.

The present invention improves the manufacturing efficiency and cost by eliminating unnecessary components that add to manufacturing costs with excessive moving components.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A combination toothbrush and toothpaste dispenser, comprising:
a) a proximal end, a distal end opposite the proximal end, a top side in between the proximal end and the distal end, and a bottom side opposite the top side and in between the proximal end and the distal end;
b) a handle at the proximal end;
c) a head operatively connected to the handle at the distal end, the handle and the head defining a chamber, wherein the head defines a hole in fluid communications with the chamber, wherein the handle and the head define a length of the toothbrush from the proximal end to the distal end;
d) a plurality of bristles projecting from the head on the top side, the bristles surrounding the hole;
e) a dispenser mounted on the handle and configured to move longitudinal along the handle in a direction from the proximal end towards the distal end, wherein the dispenser comprises a bumper housed inside the chamber; and
f) a cap defining a first compartment configured to receive the head and the bristles, the cap comprising a spike projecting into the first compartment and configured to enter the hole of the head with the cap placed on the head.

2. The combination toothbrush and toothpaste dispenser of claim 1, wherein the cap comprises a lid, and the spike is mounted on the lid.

3. The combination toothbrush and toothpaste dispenser of claim 2, further comprising a spacer configured to be positioned between the lid and the cap to create a distance between the cap and the lid sufficient to prevent the spike from entering the hole.

4. The combination toothbrush and toothpaste dispenser of claim 2, further comprising a tube configured to extend substantially the length of the toothbrush, wherein the tube is configured to be housed in the chamber.

5. The combination toothbrush and toothpaste dispenser of claim 4, wherein the tube comprises a stent, wherein the stent defines an opening that is aligned with the spike to receive the spike.

6. The combination toothbrush and toothpaste dispenser of claim 4, wherein the handle and the head are defined by an upper housing, and a lower housing, the upper housing removably connected to the lower housing, and wherein the tube comprises a flap along a perimeter of the tube, wherein the flap is configured to be sandwiched between the upper housing and the lower housing.

7. The combination toothbrush and toothpaste dispenser of claim 4, wherein the handle and the head are defined by an upper housing, and a lower housing, the upper housing removably connected to the lower housing, and wherein the tube comprises a first flap at the proximal end and a second flap at the distal end, and wherein one of the lower housing or upper housing comprises a first catch at the proximal end and a second catch at the distal end, and the other of the lower housing or upper housing comprises a first reciprocal catch at the proximal end and a second reciprocal catch at the distal end, wherein the first catch is connected to the first reciprocal catch with the first flap therebetween, and the second catch is connected to the second reciprocal catch with the second flap therebetween.

8. The combination toothbrush and toothpaste dispenser of claim 2, wherein the handle and the head are defined by an upper housing, and a lower housing, the upper housing removably connected to the lower housing, and wherein a film is attached to the lower housing along a perimeter of the lower housing.

9. The combination toothbrush and toothpaste dispenser of claim 2, wherein the spike is configured to move relative to the lid from a reset configuration to a depressed configuration.

10. The combination toothbrush and toothpaste dispenser of claim 9, wherein the lid defines a hole through which the spike is inserted, and the lid comprises a locking tab configured to slide from a locked configuration in which the spike is locked in the reset configuration, to an unlocked configuration in which the spike can be depressed.

11. The combination toothbrush and toothpaste dispenser of claim 10, wherein the lid comprises a spring configured to bias the spike upwardly towards the reset configuration.

12. A combination toothbrush and toothpaste dispenser, comprising:
a) a proximal end, a distal end opposite the proximal end, a top side in between the proximal end and the distal end, and a bottom side opposite the top side and in between the proximal end and the distal end;
b) a handle at the proximal end;
c) a head operatively connected to the handle at the distal end, the handle and the head defining a chamber, wherein the head defines a hole in fluid communications with the chamber, wherein the handle and the head define a length of the toothbrush from the proximal end to the distal end;
d) a plurality of bristles projecting from the head on the top side, the bristles surrounding the hole; and
e) a film configured to extend substantially the length of the toothbrush and operatively attached to the handle and head to contain toothpaste inside the handle and the head.

13. The combination toothbrush and toothpaste dispenser of claim 12, wherein the handle and the head are defined by an upper housing, and a lower housing, the upper housing removably connected to the lower housing, wherein the film is part of a tube defining a flap along a perimeter of the tube, wherein the flap is configured to be sandwiched between the upper housing and the lower housing.

14. The combination toothbrush and toothpaste dispenser of claim 12, further comprising a dispenser mounted on the handle and configured to move longitudinally along the handle in the direction of the proximal end towards the distal end, wherein the dispenser comprises a slider mounted on the top side of the handle and a bumper housed inside the chamber.

15. The combination toothbrush and toothpaste dispenser of claim 12, wherein the top side of the handle is pliable.

16. The combination toothbrush and toothpaste dispenser of claim 12, further comprising a cap, a lid to cover the cap, and a spike formed on the lid and configured to puncture a hole through the film when the can and lid are placed on the head.

17. The combination toothbrush and toothpaste dispenser of claim 16, wherein the spike is configured to move relative to the lid from a reset configuration to a depressed configuration.

18. The combination toothbrush and toothpaste dispenser of claim 17, wherein the lid defines a hole through which the spike is inserted, and the lid comprises a locking tab configured to slide from a locked configuration in which the spike is locked in the reset configuration, to an unlocked configuration in which the spike can be depressed.

19. The combination toothbrush and toothpaste dispenser of claim 18, wherein the lid comprises a spring configured to bias the spike upwardly towards the reset configuration.

20. The combination toothbrush and toothpaste dispenser of claim 12, wherein the file comprises polyethylene terephthalate or polyethylene.
